(19) United States
(12) Patent Application Publication
(10) Pub. No.: US 2024/0425654 A1
(43) Pub. Date: Dec. 26, 2024

(54) HIGH-STRENGTH, WARPING-RESISTANT, FLAME-RETARDANT PC COMPOSITE MATERIAL AND APPLICATION THEREOF

(71) Applicant: Guangdong Xingshengdi Technology Co., Ltd., Dongguan, Guangdong (CN)

(72) Inventors: Rongqiao Xie, Dongguan (CN); Haifeng Tu, Dongguan, (CN); Shan He, Dongguan (CN)

(21) Appl. No.: 18/650,141

(22) Filed: Apr. 30, 2024

(30) Foreign Application Priority Data
Jun. 26, 2023 (CN) 202310754760.0

(51) Int. Cl. C08J 5/04; C08K 5/00; C08K 5/20; C08K 5/523; C08K 7/20; C08K 7/28

(52) U.S. Cl. CPC C08J 5/043; C08K 5/005; C08K 5/20; C08K 5/523; C08K 7/20; C08K 7/28; C08K 2201/003

(57) ABSTRACT

The present invention relates to a high-strength, warping-resistant, flame-retardant PC composite material and application thereof. Raw materials for preparing the high-strength, warping-resistant, flame-retardant PC composite material provided by the present invention include the following components by weight: 100 parts of PC, 7-15 parts of a reinforcer, 1-8 parts of a toughener; 3-12 parts of a fire retardant, 0.1-3 parts of an antioxidant; 0.1-3.5 parts of a lubricant, and 0-3 parts of another processing aid, wherein the PC is a composite PC raw material obtained by mixing PC raw materials of different viscosities; the reinforcer includes a glass fiber and a glass microsphere, and a mass ratio of the glass fiber to the glass microsphere is 1:(0.5-1.5). With excellent tensile strength, bending strength, modulus, impact strength and other properties, the composite material provided by the present invention is a high-performance composite material with high strength and rigidity.

### CROSS-REFERENCE TO RELATED APPLICATION

The present application claims priority from Chinese Patent Application No. 202310754760.0 filed on Jun. 26, 2023, the contents of which are incorporated herein by reference in their entirety.

### FIELD OF THE INVENTION

The present invention relates to the technical field of composite materials for outdoor communication devices and, in particular, to a high-strength, warping-resistant, flame-retardant PC composite material and application thereof.

### BACKGROUND OF THE INVENTION

PC (polycarbonate) is an engineering plastic with superior comprehensive properties. With excellent impact properties, dimensional stability, electrical insulation, PC can be used in fields of instruments, electrical lighting and the like. However, PC has some serious shortcomings, such as poor processability, high stress cracking, sensitive to notches poor wear resistance, and poor chemical resistance. Modification of PC is an effective way to make up for the above-mentioned property deficiencies, achieve high performance, reduce production costs, and broaden application fields. At present, the main methods to modify PC include: blending PC with other polymers and blending PC with inorganic fillers.

Using a glass fiber to improve the strength and rigidity of a PC material is one of the more conventional modification methods. By mixing PC with an appropriate amount of the glass fiber, the micro-density of PC and the mechanical strength, dimensional stability and other properties of the material can be improved. However, due to the random dispersion of the glass fiber in a PC polymer chain, a large number of stress concentration points are formed inside the polymer during molding, resulting in a reduction in the impact resistance of the composite material. Moreover, since the glass fiber has a long strip structure and poor compatibility with the PC polymer, after melt extrusion of the material, floating fibers tend to appear on the surface of the product, easily causing the problems such as radial lines occurring on the surface of the product and surface unevenness. These problems need to be further overcome.

### Technical Solution

In view of the above technical problems, a first aspect of the present invention provides a high-strength, warping-resistant, flame-retardant PC composite material. By optimizing and adjusting the specific composition and proportions of an reinforcer (such as a glass fiber), a lubricant, and a PC component in the formula of the composite material, the strength, warpage resistance, impact resistance and other properties of the composite material can be significantly improved, the processability of the composite material can also be significantly improved, and problems such as floating fibers can be suppressed.

Raw materials for preparing the high-strength, warping-resistant, flame-retardant PC composite material provided by the present invention include the following components by weight:

| | | |
|---|---|---|
| PC | 100 | parts |
| reinforcer | 7-15 | parts |
| toughener | 1-8 | parts |
| fire retardant | 3-12 | parts |
| antioxidant | 0.1-3 | parts |
| lubricant | 0.1-3.5 | parts |
| other processing aids | 0-3 | parts; |

wherein the PC is a composite PC raw material obtained by mixing PC raw materials of different viscosities; the reinforcer includes a glass fiber and a glass microsphere, and a mass ratio of the glass fiber to the glass microsphere is 1:(0.5-1.5).

As a preferred technical solution of the present invention, the composite PC raw material includes a high-viscosity PC and a low-viscosity PC, the high-viscosity PC has a melt index of 10-18 g/10 min at 330° C./2.16 kg; the melt index of the low-viscosity PC at 300° C./1.2 kg is not less than 15 g/10 min.

As a preferred technical solution of the present invention, the composite PC raw material is composed of a PC raw material with different density gradients; the PC raw material with different density gradients includes a high-density PC with a density of 1.6-2.2 g/cm³ and a low-density PC with a density of 1.1-1.3 g/cm³.

As a preferred technical solution of the present invention, a mass ratio of the high-density PC to the low-density PC is (5-10):(1-5).

As a preferred technical solution of the present invention, the glass fiber is an alkali-free chopped glass fiber having a diameter of 5-9 μm and a chopping length of 3-4.5 mm.

As a preferred technical solution of the present invention, the glass microsphere is a high-strength hollow glass microsphere having a compressive strength of no less than 35 MPa.

As a preferred technical solution of the present invention, the high-strength hollow glass microsphere has a particle size of 10-100 μm, and the particle size D90 of the high-strength hollow glass microsphere is not greater than 90 μm.

As a preferred technical solution of the present invention, the lubricant includes a long-carbon-chain alkyl acid amide; a carbon chain length of the long-carbon-chain alkyl acid amide is at least within a range of 12 to 20, and an alkyl chain length of the alkyl acid amide is at least 16 or above.

As a preferred technical solution of the present invention, the lubricant further includes a fatty acid salt, and a mass ratio of the fatty acid salt to the long-carbon-chain alkyl acid amide salt is 1:(1-1.5).

A second aspect of the present invention provides an application of the high-strength, warping-resistant flame-retardant PC composite material as described above in the technical field of outdoor communication devices.

### Beneficial Effect

Compared with existing related materials, the high-strength, warping-resistant, flame-retardant PC composite material provided by the present invention has the following beneficial effects:

In the present invention, by optimizing the composition of the PC component, the processability of the composite material can be improved to a certain extent, so that the material can be melted and extruded more smoothly. Moreover, the impact resistance of the composite material can be significantly improved by using the PC component with different viscosities. In addition, when a glass fiber is used to reinforce a PC material, due to the difference in viscosity, density and other properties between the glass fiber and PC melt, problems such as floating fibers appearing on the surface of the composite material affects the surface gloss of the material, and this problem is particularly serious when the content of the glass fiber is high. The problem of floating fibers can be significantly ameliorated by partially replacing the glass fiber in the reinforcer with the glass microsphere. Moreover, adding an appropriate amount of the glass microsphere to replace the glass fiber partially can hinder the orderly arrangement of polymer chain segments, effectively avoid the orientation of the composite material, and help improve the warpage resistance and dimensional stability of the composite material.

With excellent tensile strength, bending strength, modulus, impact strength and other properties, the composite material provided by the present invention is a high-performance composite material with high strength and rigidity. In addition, the composite material provided by the present invention also has excellent low warpage and can maintain excellent dimensional stability during use. In the meanwhile, the composite material has excellent flame retardancy and aging resistance. Products made from this composite material can be widely used in the field of outdoor communication devices and have a longer service life. In addition, the composite material provided by the present invention has excellent processability, and the surface of the obtained product is smooth, and the problems such as floating fibers caused by the addition of glass fibers (GF) that affect the appearance of the product are ameliorated.

### EMBODIMENTS OF THE INVENTION

When contents, amounts, or other values or parameters in the present application are expressed as ranges, preferred ranges, or ranges defined by a series of preferred upper limits and preferred lower limits, this should be understood as specifically disclosing all ranges formed by any pairing of any upper range limit or preferred value with any lower range limit or preferred value, regardless of whether the range is separately disclosed. For example, in a case where a range “2 to 8” is disclosed, the described range should be interpreted as including ranges “2 to 8”, “2 to 7”, “2 to 6”, “2 to 5 and 6, 7”, and “2 to 3 and 4 to 8”.

When a numerical range is described herein, unless otherwise stated, the range is intended to include the endpoints thereof and all integers and fractions within the range. The singular includes the plural unless the context clearly indicates otherwise. “Optional” or “any” means that the matter or event subsequently described may or may not occur, and the description includes circumstances in which the event occurs and circumstances in which the event does not occur.

Raw materials for preparing the high-strength, warping-resistant, flame-retardant PC composite material provided by the present invention include the following components by weight:

| | | |
|---|---|---|
| PC | 100 | parts |
| reinforcer | 7-15 | parts |
| toughener | 1-8 | parts |
| fire retardant | 3-12 | parts |
| antioxidant | 0.1-3 | parts |
| lubricant | 0.1-3.5 | parts |
| other processing aids | 0-3 | parts; |

wherein the PC is a composite PC raw material obtained by mixing PC raw materials of different viscosities; the reinforcer includes a glass fiber and a glass microsphere, and a mass ratio of the glass fiber to the glass microsphere is 1:(0.5-1.5).

The PC described herein refers to polycarbonate, which is a high molecular polymer containing carbonate groups in its molecular chain. In the present invention, the specific composition of the PC component is not particularly limited, and bisphenol A-type PC and other components well known in the art may be used. Since PC materials have high thermal deformation temperature, the PC fluid obtained after heating and melting has poor fluidity and is difficult to mold. The composite material of the present application uses a composite PC raw material obtained by mixing PC raw materials of different viscosities. The composite PC raw material obtained by mixing PC raw materials of different viscosities is obtained by mixing at least two or more PC materials of different viscosities.

In some embodiments of the present invention, the composite PC raw material includes a high-viscosity PC material and a low-viscosity PC material. The terms “high-viscosity” and “low-viscosity”, as used herein, refer to relative viscosities, which are intended to distinguish different PC raw materials, but do not mean that reaching a specific viscosity or above is considered high viscosity or being below a specific viscosity is considered low viscosity.

The term “melt index”, as used herein, refers to the melt mass flow rate (MFR) and it refers to the mass grams of the material melt after heating and melting that passes through a circular tube of a specified diameter within 10 min at a specific temperature and load pressure. The melt index used herein is tested according to the ASTM D1238 standard.

Further, the melt index of the high-viscosity PC material at 330° C./2.16 kg in the present invention is within a range of 10 g/10 min to 18 g/10 min and, exemplarily, the melt index of the high-viscosity PC material may be 10 g/10 min, 11 g/10 min, 12 g/10 min, 13 g/10 min, 14 g/10 min, 15 g/10 min, 16 g/10 min, 17 g/10 min, 18 g/10 min, and the like. Further, the melt index of the low-viscosity PC material at 300° C./1.2 kg in the present invention is not less than 15 g/10 min and, exemplarily, the melt index of the low-viscosity PC material may be 15 g/10 min, 16 g/10 min, 17 g/10 min, 18 g/10 min, 19 g/10 min, 20 g/10 min, 21 g/10 min, 22 g/10 min, 23 g/10 min, 24 g/10 min, 25 g/10 min, and the like. Further, it is preferred that the melt index of the low-viscosity PC material at 300° C./1.2 kg is within a range of 17 g/10 min to 21 g/10 min.

In some embodiments of the present invention, the composite PC raw material is composed of a PC raw material with different density gradients. The PC raw material with different density gradients, as used herein, refers to the raw material obtained by mixing two or more PC materials of different densities, wherein the density difference between any two PC raw materials is at least 0.15 g/cm3. Further, the PC with different density gradients includes a high-density PC and a low-density PC. Further, it is preferred that the density of the high-density PC is within a range of 1.6 g/cm3 to 2.2 g/cm3 and, exemplarily, the density of the high-density PC may be 1.6 g/cm3, 1.65 g/cm3, 1.7 g/cm3, 1.75 g/cm3, 1.8 g/cm3, 1.85 g/cm3, 1.9 g/cm3, 1.95 g/cm3, 2.0 g/cm3, 2.1 g/cm3, 2.2 g/cm3, and the like; the density of the low-density PC is within a range of 1.1 g/cm3 to 1.3 g/cm3 and, exemplarily, the density of the low-density PC may be 1.1 g/cm3, 1.15 g/cm3, 1.17 g/cm3, 1.2 g/cm3, 1.23 g/cm3, 1.25 g/cm3, 1.27 g/cm3, 1.3 g/cm3, and the like.

In some embodiments, the mass ratio of the high-density PC to the low-density PC is (5-10):(1-5) and, exemplarily, the mass ratio may be 5:1, 6:1, 7:1, 8:1, 9:1, 10:1, 5:3, 6:3, 7:3, 8:3, 7:5, 8:5, 9:5, 2:1 and the like. It is preferred that the mass ratio is 7:3.

The PC raw material with different density gradients, used herein, may be a PC material with different viscosities at the same time, and the formula of the PC with different density gradients and the formula of the PC material with different viscosities may also be regarded as independent technical solutions. Further, the PC component in the high-strength warp-resistant flame-retardant PC composite material includes the PC with different density gradients and the PC with different viscosities at the same time, that is, the high-density PC may be a low-viscosity PC raw material/high-viscosity PC raw material and the low-density PC may be a high-viscosity PC raw material/low-viscosity PC raw material.

In the present application, the specific sources of PC raw materials that meet the above requirements are not particularly limited. Various commercially available products well known to those skilled in the art may be used, including but not limited to products from Idemitsu (Japan), Idemitsu (Taiwan), Covestro and other companies, such as IR1900/Idemitsu (Japan), 1700/Covestro, etc.

In the process of implementing the present invention, it is found that the processability of the composite material may be improved to a certain extent by optimizing the composition of the PC component, so that the material can be melted and extruded more smoothly. Moreover, the impact resistance of the composite material may also be significantly improved by using the PC component with different viscosities. The applicant speculates that, since the PC materials of different viscosities have different melting temperatures and they are quite different in melt fluidity at the same temperature, the high-fluidity material melt penetrating into the high-viscosity PC material to be melted accelerates the melting of the high-viscosity PC material so that the melt material can be better extruded and molded. In addition, due to the interpenetration of the random packing structures of polymer chain segments when the PC materials of different viscosities are cooled after extrusion, a specific microstructure in which relatively loose random packing and relatively dense packing microstructures are interrelated is formed and they can transmit an external stress to each other when subjected to the external stress. The relatively loose microstructure can absorb part of the energy through processes such as deformation, preventing the material from fragmenting due to external impact, and improving the impact resistance of the composite material. In the meanwhile, the dimensional stability of the material is maintained due to the higher cohesive strength of the relatively dense microstructure.

The raw materials for preparing the high-strength, warping-resistant, flame-retardant PC composite material of the present invention further include a certain amount of a reinforcer. The reinforcer is a component that is mixed with the PC raw material to improve the strength of the composite material. The reinforcer may be an organic component that can be mixed with PC to improve strength, or it may be an inorganic component. The reinforcer in the composite material of the present invention at least includes an inorganic reinforcing component. Further, the reinforcer includes a glass fiber (GF) and a glass microsphere. Further, the mass ratio of the glass fiber to the glass microsphere is 1:(0.5-1.5) and, exemplarily, the mass ratio may be 1:0.5, 1:0.7, 1:0.8, 1:1, 1:1.1, 1:1.15, 1:1.2, 1:1.25, 1:1.3, 1:1.35, 1:1.4, 1:1.45, 1:1.5, and the like.

The glass fiber of the present invention is a component obtained by melting glass balls or cullet and drawing the melt. The glass fiber of the present invention may be a glass filament or a chopped glass fiber. The glass microsphere used herein is a hollow glass sphere made from a borosilicate raw material. Depending on the specific raw material and specification, the glass microsphere has different particle size, compressive strength, oil absorption, and other parameters.

In the process of implementing the present invention, it is found that, when the glass fiber is used to reinforce the PC material, due to the difference in viscosity, density and other properties between the glass fiber and the PC melt, problems such as floating fibers appearing on the surface of the composite material is caused and affects the surface gloss of the material, and this problem is particularly serious when the content of the glass fiber is high. The problem of floating fibers can be significantly ameliorated by partially replacing the glass fiber in the reinforcer with the glass microsphere. In addition, due to the large differences in the length and radial dimensions of the glass fiber, the composite material is oriented during the melt extrusion and processing molding processes, resulting in different shrinkage capabilities in different directions and causing problems such as warpage of the molded sheet and poor dimensional stability. Moreover, adding an appropriate amount of the glass microsphere to partially replace the glass fiber can hinder the orderly arrangement of polymer chain segments, effectively avoid the orientation of the composite material, and help improve the warpage resistance and dimensional stability of the composite material.

In some preferred embodiments of the present invention, the glass fiber is an alkali-free chopped glass fiber having a diameter of 5-9 μm and a chopping length of 3-4.5 mm. The alkali-free chopped glass fiber described herein is a fiber obtained by chopping E glass fiber to a specific size, where the E glass refers to glass with a low alkali metal oxide content, and the specific content of the alkali metal oxide is stipulated to be no more than about 1% in China, which can be determined specifically according to methods well known to those skilled in the art. Preferably, the diameter of the alkali-free chopped glass fiber described herein is within a range of 5 μm to 9 μm and, exemplarily, the diameter may be 5 μm, 5.5 μm, 6 μm, 6.5 μm, 7 μm, 7.5 μm, 8 μm, 8.5 μm, 9 am, and the like; the chopping length of the alkali-free chopped glass fiber is within a range of 3 mm to 4.5 mm and, exemplarily, the chopping length may be 3 mm, 3.5 mm, 4 mm, 4.5 mm and the like.

In the present invention, the source of the alkali-free chopped glass fiber that meets the above requirements is not particularly limited. Commercially available products well known to those skilled in the art may be used, for example, including but not limited to ECS303A series products from Chongqing International Polycom International Corporation.

In some preferred embodiments of the present invention, the glass microsphere is a high-strength hollow glass microsphere, and the compressive strength of the high-strength hollow glass microspheres is not less than 35 MPa; further, it is preferred that the compressive strength of the hollow glass microspheres is within a range of 35 MPa to 55 MPa and, exemplarily, the compressive strength may be 35 MPa, 38 MPa, 40 MPa, 41 MPa, 43 MPa, 45 MPa, 47 MPa, 50 MPa, 52 MPa, 55 MPa, and the like.

In the process of implementing the present invention, it is found that adding an appropriate amount of the hollow glass microsphere can improve the strength of the composite material to a great extent. However, if the specification and properties of the selected hollow glass microsphere are inappropriate, the strength of the composite material will be reduced, which further affects the impact resistance of the material. For example, when the compressive strength of the hollow glass microsphere used is low, hollow glass microspheres are broken during the melt extrusion process of the material and irregularly dispersed inside the material, as a result, a large number of stress concentration points are formed, brittle fracture occurs due to uneven stress on the composite material, and the mechanical strength of the composite material is thus affected. The term “compressive strength of the high-strength hollow glass microsphere”, as used herein, refers to the maximum pressure (MPa) that the glass microsphere can withstand before being destroyed.

The compressive strength, as used herein, can be tested according to methods well known to those skilled in the art.

In some preferred embodiments of the present invention, the particle size of the high-strength hollow glass microsphere is within a range of 10 μm to 100 μm, and the particle size D90 is not greater than 90 μm. Further it is preferred that the median particle size (D50) of the high-strength hollow glass microsphere is within a range of 42 μm to 50 μm and, exemplarily, its median particle size may be 42 μm, 43 μm, 44 μm, 45 μm, 46 μm, 47 μm, 48 μm, 49 μm, 50 μm, and the like.

The term “particle size D90”, as used herein, refers to the particle size corresponding to the case in which the cumulative particle size distribution number of the glass microsphere reaches 90%. Its test method is not particularly limited and the particle size D90 can be tested according to methods well known to those skilled in the art, such as screening method.

In the present invention, the specific source of the glass microsphere that meets the above requirements is not particularly limited. Various commercially available products well known to those skilled in the art may be used, including but not limited to Y6000, Y8000, Y12000 and other products from Sinosteel Maanshan Mining Institute New Materials Technology Co., Ltd.

The raw materials for preparing the high-strength, warping-resistant, flame-retardant PC composite material of the present invention include a certain amount of a toughener, and the use amount of the toughener is within a range of 1 part to 8 parts by weight based on 100 parts by weight of the PC raw material. The toughener described herein is a polymer material that can improve the toughness of the composite material, including but not limited to elastomeric polymers that have good compatibility with PC components. Exemplarily, the composition of the toughener includes but is not limited to SBS, SIS, SEBS, MBS, and the like.

In some preferred embodiments of the present invention, the toughener is an MBS polymer, and the MBS polymer is a polymer obtained by free radical polymerization of reaction monomers: methyl methacrylate, styrene and butadiene. In some preferred embodiments, the MBS polymer is a polymer having a core-shell structure, prepared by using styrene and butadiene as a core layer and methyl methacrylate as a shell layer. In the present invention, the source of the MBS polymer that meets the above requirements is not particularly limited, and commercially available related materials can be used, such as but not limited to MBS products with the brand name C-223A from Mitsubishi (Japan).

The raw materials for preparing the high-strength, warping-resistant, flame-retardant PC composite material of the present invention include a certain amount of a flame retardant. A halogen flame retardant or a halogen-free flame retardant may be used, and a halogen-free flame retardant is preferably used. The specific type of the halogen-free flame retardant is not particularly limited in the present invention. Various halogen-free flame retardants well known to those skilled in the art may also be used, including but not limited to inorganic flame retardants, nitrogen-containing flame retardants, silicon-based flame retardants, and phosphorus-containing flame retardants. Preferably, the present application adopts a phosphorus-containing flame retardant which includes one or more of polyaryl phosphate, resorcinol tetraphenyl diphosphate (RDP) and bisphenol A bis(diphenyl phosphate) (BDP).

The raw materials for preparing the high-strength, warp-resistant, flame-retardant PC composite material in the present invention include a certain amount of an antioxidant. The antioxidant prevents functional losses caused by aging and degradation of the composite material during use. The use amount of the antioxidant in the present invention can be determined according to specific needs. In some embodiments, based on 100 parts by weight of the PC component in the composite material, the use amount of the antioxidant may be within a range of 0.1 part to 3 parts, by weight.

The specific type of the antioxidant is not particularly limited in the present invention. Various antioxidants well known to those skilled in the art may be used, including but not limited to aromatic amine antioxidants, hindered phenolic antioxidants, and hindered amine antioxidants, and, exemplarily, the antioxidant includes but is not limited to antioxidant 1010, antioxidant 168, antioxidant 1076, antioxidant DLTDP, antioxidant DSTDP, and bis(2,6-di-tert-butyl-4-methylphenyl) pentaerythritol diphosphate (antioxidant RCPEP36).

The raw materials for preparing the high-strength, warping-resistant, flame-retardant PC composite material of the present invention include a certain amount of a lubricant. The lubricant is used to improve the fluidity of the material melt after heating and melting and reduce the friction between the melt and the inner walls of a screw extruder and other devices to reduce frictional heat generation, thereby improving the processability of the material. Various long-carbon-chain monomer compounds well known to those skilled in the art may be used as the lubricant component in the present invention, and high-molecular compounds such as polyethylene wax, microcrystalline wax, polyorganosiloxane may also be used.

In some embodiments of the present invention, the lubricant includes a long-carbon-chain alkyl acid amide. The long-carbon-chain alkyl acid amide is a compound in which hydrogen atoms in the amide bond in the molecular structure are replaced by long-carbon-chain alkyl groups. Since there is an alkyl chain of a certain length in the molecular structure of alkyl acid amide, the amide bond in the molecular structure of the long-carbon-chain alkyl acid amide is located in the middle of the compound molecule, and the two ends of the compound molecule are substituted by carbon or alkyl chains of different lengths and/or the same length.

In some preferred embodiments of the present invention, the carbon chain length of the long-carbon-chain alkyl acid amide is at least 12. In some embodiments, the carbon chain length of the long-carbon-chain alkyl acid amide is within a range of 12 to 20. Exemplarily, the long-carbon-chain alkyl acid amide may be N-dodecyl-alkyl acid amide, N-tetradecyl-alkyl acid amide, N-hexadecyl-alkyl acid amide, N-octadecyl-alkyl acid amide, N-eicosyl-alkyl acid amide, etc.

In some preferred embodiments of the present invention, the alkyl chain length of the alkyl acid amide in the long-carbon-chain alkyl acid amide is at least 16 or more. Exemplarily, the long-carbon-chain alkyl acid amide may be N-(12 to 20)alkyl-palmitic acid amide, N-(12 to 20)alkyl-oleic acid amide, N-(12 to 20)alkyl-stearic acid amide, N-(12 to 20)alkyl-erucamide, etc. Specifically, the long-carbon-chain alkyl acid amide may be N-dodecyl-erucamide, N-tetradecyl-erucamide, N-hexadecyl-erucamide, N-octadecyl-erucamide, etc.

In some preferred embodiments of the present invention, the lubricant further includes a fatty acid salt. The fatty acid salt here is a compound of a long-carbon-chain hydrocarbon fatty acid and a metal. The fatty acid is a saturated/unsaturated fatty acid with a carbon chain length of 14 to 20 and, which, exemplarily, may be oleic acid, stearic acid, etc. Exemplarily, the fatty acid salt may be sodium stearate, potassium stearate, sodium oleate, potassium oleate, and calcium stearate. In some preferred embodiments of the present invention, the mass ratio of the fatty acid salt to the long-carbon-chain alkyl acid amide salt is 1:(1-1.5) and exemplarily, the ratio may be 1:1, 1:1.1, 1:1.2, 1:1.3, 1:1.4, 1:1.5, etc.

In the process of implementing the present invention, it is found that by the combination of the fatty acid salt such as calcium stearate and the long-carbon-chain alkyl acid amide such as N-octadecyl-erucamide, the friction between the material and the inner walls of melt extrusion devices can be greatly improved, thereby obtaining better lubrication effect and also ameliorating and preventing the floating fiber problem of the product to a great extent. In addition, it is also found that when the compound lubricant described above is used, the combination of the glass fiber and the glass microsphere with the PC materials of different densities can significantly improve the appearance of the product and solve the problem of floating fibers.

In the present invention, in order to further improve the comprehensive performance of the composite material, an appropriate amount of another processing aid may also be added according to specific needs. The other aid includes but is not limited to an anti-ultraviolet agent, an anti-drip agent, a light stabilizer, and heat stabilizer, a release agent, a toner, or the like. The specific use amount of the other processing aid may be determined according to specific needs. For example, based on 100 parts by weight of the PC component, the use amount of the other processing aid may be within a range of 0 to 3 parts, etc.

In some preferred embodiments, the raw materials for preparing the high-strength, warping-resistant, flame-retardant PC composite material include the following components by weight:

| | | |
|---|---|---|
| high-viscosity PC | 65-80 | parts |
| low-viscosity PC | 25-40 | parts |
| GF reinforcer | 4-8 | parts |
| glass microsphere reinforcer | 3-7 | parts |
| toughener | 1-8 | parts |
| fire retardant | 3-12 | parts |
| antioxidant | 0.1-3 | parts |
| long-carbon-chain alkyl acid amide lubricant | 0.8-2.5 | parts |
| fatty acid salt lubricant | 0.5-1.5 | parts |
| heat stabilizer | 0-3 | parts. |

In the present invention, the preparation method of the high-strength, warping-resistant, flame-retardant PC composite material is not particularly limited. It can be processed and prepared according to methods well known to those skilled in the art. For example, melt extrusion processing may be used. Specifically, dried raw materials are measured according to their proportions, and the PC, the toughener, the flame retardant, the antioxidant, the lubricant and other raw materials are blended and added to a twin-screw extruder, and then the reinforcer is added to the twin-screw extruder and the raw materials are then subjected to heating, melting, extruding, drawing, cooling, granulating and post-processing to obtain the high-strength, warping-resistant, flame-retardant PC composite material, where the specific processing temperature, feeding speed and other process conditions can be adjusted accordingly according to an actual situation.

A second aspect of the present invention provides an application of the high-strength, warping-resistant flame-retardant PC composite material as described above in the technical field of outdoor communication devices.

The present invention will be described in detail below by examples. It should also be noted here that the following examples are only used to further illustrate the invention and cannot be understood as limiting the scope of the invention. Some non-essential improvements and adjustments made by those skilled in the art according to the above content of the invention still fall within the scope of the invention.

### Example 1

Raw materials for preparing the high-strength, warping-resistant, flame-retardant PC composite material provided in this example include the following components by weight:

| | | |
|---|---|---|
| high-viscosity PC | 70 | parts |
| low-viscosity PC | 30 | parts |
| GF reinforcer | 6 | parts |
| glass microsphere reinforcer | 5 | parts |
| toughener | 4 | parts |
| fire retardant | 9 | parts |
| antioxidant | 2 | parts |
| long-carbon-chain alkyl acid amide lubricant | 1.5 | parts |
| fatty acid salt lubricant | 1 | part |
| heat stabilizer | 1 | part. |

The low-viscosity PC was PC IR1900 (Idemitsu, Japan) with a density of 1.9 g/cm3 and a melt index of 19 g/10 min at 300° C./1.2 kg. The high-viscosity PC was PC1700 (Covestro) with a density of 1.17 g/cm3 and a melt index of 15 g/10 min at 330° C./2.16 kg. The toughener was an MBS polymer with a core-shell structure C-223A (Mitsubishi, Japan) prepared by using styrene and butadiene as a core layer and methyl methacrylate as a shell layer. The GF reinforcer was an alkali-free chopped glass fiber ECS303A-3-E (Chongqing International Polycom International Corporation) with a fiber diameter of 7 μm and a chopping length of 3 mm. The glass microsphere reinforcer was a high-strength hollow glass microsphere Y6000 (Sinosteel Maanshan Mining Institute New Materials Technology Co., Ltd.) having a compressive strength of 41 MPa, a D90 diameter of 90 μm, and a D50 diameter of 46 μm. The flame retardant was RDP. The antioxidant was antioxidant 168. The long-carbon-chain alkyl acid amide lubricant was N-octadecyl-erucamide. The fatty acid salt lubricant was calcium stearate. The heat stabilizer was H161 (Brueggemann).

### Example 2

Raw materials for preparing the high-strength, warping-resistant, flame-retardant PC composite material provided in this example include the following components by weight:

| | | |
|---|---|---|
| low-viscosity PC | 100 | parts |
| GF reinforcer | 11 | parts |
| toughener | 4 | parts |
| fire retardant | 9 | parts |
| antioxidant | 2 | parts |
| long-carbon-chain alkyl acid amide lubricant | 2.5 | parts |
| heat stabilizer | 1 | part. |

The low-viscosity PC was PC IR1900 (Idemitsu, Japan) with a density of 1.9 g/cm3 and a melt index of 19 g/10 min at 300° C./1.2 kg. The toughener was an MBS polymer with a core-shell structure C-223A (Mitsubishi, Japan) prepared by using styrene and butadiene as a core layer and methyl methacrylate as a shell layer. The GF reinforcer was an alkali-free chopped glass fiber ECS303A-3-E (Chongqing International Polycom International Corporation) with a fiber diameter of 7 μm and a chopping length of 3 mm. The flame retardant was RDP. The antioxidant was antioxidant 168. The long-carbon-chain alkyl acid amide lubricant was N-octadecyl-erucamide. The fatty acid salt lubricant was calcium stearate. The heat stabilizer was H161 (Brueggemann).

### Example 3

Raw materials for preparing the high-strength, warping-resistant, flame-retardant PC composite material provided in this example include the following components by weight:

| | | |
|---|---|---|
| high-viscosity PC | 70 | parts |
| low-viscosity PC | 30 | parts |
| GF reinforcer | 11 | parts |
| toughener | 4 | parts |
| fire retardant | 9 | parts |
| antioxidant | 2 | parts |
| long-carbon-chain alkyl acid amide lubricant | 2.5 | parts |
| heat stabilizer | 1 | part. |

The low-viscosity PC was PC IR1900 (Idemitsu, Japan) with a density of 1.9 g/cm3 and a melt index of 19 g/10 min at 300° C./1.2 kg. The high-viscosity PC was PC1700 (Covestro) with a density of 1.17 g/cm3 and a melt index of 15 g/10 min at 330° C./2.16 kg. The toughener was an MBS polymer with a core-shell structure C-223A (Mitsubishi, Japan) prepared by using styrene and butadiene as a core layer and methyl methacrylate as a shell layer. The GF reinforcer was an alkali-free chopped glass fiber ECS303A-3-E (Chongqing International Polycom International Corporation) with a fiber diameter of 7 μm and a chopping length of 3 mm. The flame retardant was RDP. The antioxidant was antioxidant 168. The long-carbon-chain alkyl acid amide lubricant was N-octadecyl-erucamide. The fatty acid salt lubricant was calcium stearate. The heat stabilizer was H161 (Brueggemann).

### Example 4

Raw materials for preparing the high-strength, warping-resistant, flame-retardant PC composite material provided in this example include the following components by weight:

| | | |
|---|---|---|
| high-viscosity PC | 70 | parts |
| low-viscosity PC | 30 | parts |
| glass microsphere reinforcer | 11 | parts |
| toughener | 4 | parts |
| fire retardant | 9 | parts |
| antioxidant | 2 | parts |
| long-carbon-chain alkyl acid amide lubricant | 1.5 | parts |
| fatty acid salt lubricant | 1 | part |
| heat stabilizer | 1 | part. |

The low-viscosity PC was PC IR1900 (Idemitsu, Japan) with a density of 1.9 g/cm3 and a melt index of 19 g/10 min at 300° C./1.2 kg. The high-viscosity PC was PC1700 (Covestro) with a density of 1.17 g/cm3 and a melt index of 15 g/10 min at 330° C./2.16 kg. The toughener was an MBS polymer with a core-shell structure C-223A (Mitsubishi, Japan) prepared by using styrene and butadiene as a core layer and methyl methacrylate as a shell layer. The glass microsphere reinforcer was a high-strength hollow glass microsphere Y6000 (Sinosteel Maanshan Mining Institute New Materials Technology Co., Ltd.) having a compressive strength of 41 MPa, a D90 diameter of 90 μm, and a D50 diameter of 46 μm. The flame retardant was RDP. The antioxidant was antioxidant 168. The long-carbon-chain alkyl acid amide lubricant was N-octadecyl-erucamide. The fatty acid salt lubricant was calcium stearate. The heat stabilizer was H161 (Brueggemann).

### Example 5

Raw materials for preparing the high-strength, warping-resistant, flame-retardant PC composite material provided in this example include the following components by weight:

| | | |
|---|---|---|
| low-viscosity PC | 100 | parts |
| GF reinforcer | 6 | parts |
| glass microsphere reinforcer | 5 | parts |
| toughener | 4 | parts |
| fire retardant | 9 | parts |
| antioxidant | 2 | parts |
| long-carbon-chain alkyl acid amide lubricant | 1.5 | parts |
| fatty acid salt lubricant | 1 | part |
| heat stabilizer | 1 | part. |

The low-viscosity PC was PC IR1900 (Idemitsu, Japan) with a density of 1.9 g/cm3 and a melt index of 19 g/10 min at 300° C./1.2 kg. The toughener was an MBS polymer with a core-shell structure C-223A (Mitsubishi, Japan) prepared by using styrene and butadiene as a core layer and methyl methacrylate as a shell layer. The GF reinforcer was an alkali-free chopped glass fiber ECS303A-3-E (Chongqing International Polycom International Corporation) with a fiber diameter of 7 μm and a chopping length of 3 mm. The glass microsphere reinforcer was a high-strength hollow glass microsphere Y6000 (Sinosteel Maanshan Mining Institute New Materials Technology Co., Ltd.) having a compressive strength of 41 MPa, a D90 diameter of 90 μm, and a D50 diameter of 46 μm. The flame retardant was RDP. The antioxidant was antioxidant 168. The long-carbon-chain alkyl acid amide lubricant was N-octadecyl-erucamide. The fatty acid salt lubricant was calcium stearate. The heat stabilizer was H161 (Brueggemann).

### Example 6

Raw materials for preparing the high-strength, warping-resistant, flame-retardant PC composite material provided in this example include the following components by weight:

| | | |
|---|---|---|
| high-viscosity PC | 100 | parts |
| GF reinforcer | 6 | parts |
| glass microsphere reinforcer | 5 | parts |
| toughener | 4 | parts |
| fire retardant | 9 | parts |
| antioxidant | 2 | parts |
| fatty acid salt lubricant | 2.5 | parts |
| heat stabilizer | 1 | part. |

The high-viscosity PC was PC1700 (Covestro) with a density of 1.17 g/cm3 and a melt index of 15 g/10 min at 330° C./2.16 kg. The toughener was an MBS polymer with a core-shell structure C-223A (Mitsubishi, Japan) prepared by using styrene and butadiene as a core layer and methyl methacrylate as a shell layer. The GF reinforcer was an alkali-free chopped glass fiber ECS303A-3-E (Chongqing International Polycom International Corporation) with a fiber diameter of 7 μm and a chopping length of 3 mm. The glass microsphere reinforcer was a high-strength hollow glass microsphere Y6000 (Sinosteel Maanshan Mining Institute New Materials Technology Co., Ltd.) having a compressive strength of 41 MPa, a D90 diameter of 90 μm, and a D50 diameter of 46 μm. The flame retardant was RDP. The antioxidant was antioxidant 168. The fatty acid salt lubricant was calcium stearate. The heat stabilizer was H161 (Brueggemann).

### Example 7

Raw materials for preparing the high-strength, warping-resistant, flame-retardant PC composite material provided in this example include the following components by weight:

| | | |
|---|---|---|
| high-viscosity PC | 70 | parts |
| low-viscosity PC | 30 | parts |
| toughener | 4 | parts |
| fire retardant | 9 | parts |
| antioxidant | 2 | parts |
| long-carbon-chain alkyl acid amide lubricant | 1.5 | parts |
| fatty acid salt lubricant | 1 | part |
| heat stabilizer | 1 | part. |

The low-viscosity PC was PC IR1900 (Idemitsu, Japan) with a density of 1.9 g/cm3 and a melt index of 19 g/10 min at 300° C./1.2 kg. The high-viscosity PC was PC1700 (Covestro) with a density of 1.17 g/cm3 and a melt index of 15 g/10 min at 330° C./2.16 kg. The toughener was an MBS polymer with a core-shell structure C-223A (Mitsubishi, Japan) prepared by using styrene and butadiene as a core layer and methyl methacrylate as a shell layer. The flame retardant was RDP. The antioxidant was antioxidant 168. The long-carbon-chain alkyl acid amide lubricant was N-octadecyl-erucamide. The fatty acid salt lubricant was calcium stearate. The heat stabilizer was H161 (Brueggemann).

### Property Tests

Raw materials for preparing the composite materials in the above examples were dried and mixed in a high-speed mixer, then added to a twin-screw extruder for melt extrusion (the temperature of the extruder was within a range of 210° C. to 255° C.), and then drawn, cooled, granulated, and the resulting granules were dried at 120° C. for 2 h and then injection molded to prepare 1-type experimental specimens (180 mm*20 mm*4 mm) for testing tensile properties: The above specimens were tested for tensile properties according to the ASTM D638 standard at the tensile speed of 50 mm/min, and the tensile strength and elongation at break of the specimens were investigated respectively.

Specimens (80 mm*10 mm*4 mm) for bending test were prepared according to the ASTM D790 standard, and the above test specimens were tested for bending strength at a test rate of 10 mm/min.

According to the ISO180 standard, the cantilever beam notch strength test was carried out at normal temperature (25° C.). The specification of specimens was 65 mm*12 mm*4 mm, and the remaining thickness at the bottom of the notch was 3.2 mm.

The results of property tests are shown in Table 1 below.

TABLE 1

| | Tensile | | Tensile | Bending | Impact |
|---|---|---|---|---|---|
| | strength/ | Elongation | modulus/ | strength/ | strength/ |
| | MPa | at break/% | MPa | MPa | (kJ/m²) |
| Example 1 | 89 | 57 | 4866 | 134 | 71 |
| Example 2 | 73 | 102 | 3964 | 97 | 56 |
| Example 3 | 76 | 91 | 4215 | 105 | 64 |
| Example 4 | 90 | 43 | 4981 | 137 | 42 |
| Example 5 | 86 | 84 | 4518 | 121 | 63 |
| Example 6 | 83 | 36 | 4703 | 127 | 25 |
| Example 7 | 61 | 122 | 2350 | 89 | 76 |

The warpage resistance of the injection molded specimens was tested according to their shrinkage and warpage under the same environment. Specifically, the raw materials for preparing the composite materials in the above examples were injection molded according to the proportions to prepare square specimens which were 3 mm in thickness, 200 mm in length and 200 in width, and the square specimens were then placed in a constant temperature and humidity chamber with a temperature of 25° C. and a humidity of 70% for 3 days. Then, the square specimens were taken out and observed for their warpage. The square specimens were classified according to severe warpage, obvious warpage, slight warpage, and no warpage, corresponding to the four categories A, B, C, and D, respectively.

In addition, the quality inspection personnel observed the surfaces of the test specimens for tensile test obtained by injection molding after melt extrusion of the composite materials in the above examples in a twin-screw extruder. The test specimens were scored according to whether radial lines appear on the surface, whether the surface is smooth, and whether floating fibers appear and other phenomena. If no radial lines are observed and the surface of the specimen is smooth, the score of the specimen is between 8 and 10. If subtle radial lines are observed but the surface of the specimen is relatively smooth, the score of the specimen is between 5 and 7. More radial stripes are observed and the surface of the specimen is not smooth enough, the score of the specimen is between 3 and 4. If serious floating fibers occur, a large number of lines are observed and the surface of the specimen is rough, the score of the specimen is between 1 and 2. Ten specimens were observed for the composite material in each case, and their average score F is taken. If F≥8.5, the specimen will be rated as grade A; if 7.0≤F<8.5, the specimen will be graded as grade B; if 5.5≤F<7.0, the specimen will be graded as grade C; and if F<5.5, the specimen will be rated as grade D.

According to the S04892-2:2013 standard, the specimens in the above Examples to 7 were subjected to a weathering test (xenon arc aging), and the color difference ΔE after 1000 h of xenon arc aging was recorded to characterize the weather resistance. The composite materials in the above Examples 1 to 7 were made into 1.0 mm thick specimens, and the flame retardant properties were tested according to the LUL94 standard.

The results of property tests stated above are shown in Table 2 below.

TABLE 2

| | Warpage | | Weather | |
|---|---|---|---|---|
| | resistance | Appearance | resistance ΔE | UL94 |
| Example 1 | D | A | 2.1 | V0 |
| Example 2 | C | C | 2.7 | V0 |
| Example 3 | D | C | 2.3 | V0 |
| Example 4 | D | A | 2.2 | V0 |
| Example 5 | C | B | 2.5 | V0 |
| Example 6 | D | B | 2.1 | V0 |
| Example 7 | B | A | 2.2 | V0 |

According to the above experimental test results, the composite material provided by the present invention has excellent tensile strength, bending strength, modulus, impact strength and other properties, and is a high-performance composite material with high strength and rigidity. In addition, the composite material provided by the present invention also has excellent low warpage and can maintain excellent dimensional stability during use. In the meanwhile, the composite material has excellent flame retardancy and aging resistance. Products made from this composite material can be widely used in the field of outdoor communication devices and have a longer service life. In addition, the composite material provided by the present invention has excellent processability, and the appearance of the obtained product is smooth, and the problems such as floating fibers caused by the addition of GF that affect the appearance of the product are ameliorated.

The above are only exemplary embodiments of the present disclosure and do not limit the scope of the present disclosure. That is, all equivalent changes and modifications made based on the teachings of the present disclosure are still within the scope of the present disclosure. Those skilled in the art will readily conceive of other implementation solutions of the present disclosure after considering this description and practicing the content disclosed herein. The present application is intended to cover any variations, uses, or adaptive changes of the present disclosure. These variations, uses, or adaptive changes follow the general principles of the present disclosure and include common knowledge or conventional technical means in the technical field that are not disclosed in the present disclosure. The description and the embodiments are regarded as exemplary only, and the true scope and spirit of the present disclosure are defined by the Claims.

1. A high-strength, warping-resistant, flame-retardant PC composite material, wherein raw materials for preparing the high-strength, warping-resistant, flame-retardant PC composite material comprise the following components by weight:

| | | |
|---|---|---|
| PC | 100 | parts |
| reinforcer | 7-15 | parts |
| toughener | 1-8 | parts |
| fire retardant | 3-12 | parts |
| antioxidant | 0.1-3 | parts |
| lubricant | 0.1-3.5 | parts |
| another processing aid | 0-3 | parts; |

wherein the PC is a composite PC raw material obtained by mixing PC raw materials of different viscosities; the reinforcer comprises a glass fiber and a glass microsphere, and a mass ratio of the glass fiber to the glass microsphere is 1:(0.5-1.5).

2. The high-strength, warping-resistant, flame-retardant PC composite material according to claim 1, wherein the composite PC raw material comprises a high-viscosity PC and a low-viscosity PC, the high-viscosity PC has a melt index of 10-18 g/10 min at 330° C./2.16 kg; the melt index of the low-viscosity PC at 300° C./1.2 kg is not less than 15 g/10 min.

3. The high-strength, warping-resistant, flame-retardant PC composite material according to claim 1, wherein the composite PC raw material is composed of a PC raw material with different density gradients; the PC raw material with different density gradients comprises a high-density PC with a density of 1.6-2.2 g/cm³ and a low-density PC with a density of 1.1-1.3 g/cm³.

4. The high-strength, warping-resistant, flame-retardant PC composite material according to claim 3, wherein a mass ratio of the high-density PC to the low-density PC is (5-10):(1-5).

5. The high-strength, warping-resistant, flame-retardant PC composite material according to claim 1, wherein the glass fiber is an alkali-free chopped glass fiber having a diameter of 5-9 μm and a chopping length of 3-4.5 mm.

6. The high-strength, warping-resistant, flame-retardant PC composite material according to claim 5, wherein the glass microsphere is a high-strength hollow glass microsphere having a compressive strength of no less than 35 MPa.

7. The high-strength, warping-resistant, flame-retardant PC composite material according to claim 5, wherein the high-strength hollow glass microsphere has a particle size of 10-100 μm, and the particle size D90 of the high-strength hollow glass microsphere is not greater than 90 μm.

8. The high-strength, warping-resistant, flame-retardant PC composite material according to claim 1, wherein the lubricant comprises a long-carbon-chain alkyl acid amide; a carbon chain length of the long-carbon-chain alkyl acid amide is at least within a range of 12 to 20, and an alkyl chain length of the alkyl acid amide is at least 16 or above.

9. The high-strength, warping-resistant, flame-retardant PC composite material according to claim 8, wherein the lubricant further comprises a fatty acid salt, and a mass ratio of the fatty acid salt to the long-carbon-chain alkyl acid amide salt is 1:(1-1.5).

10. An outdoor communication device, comprising the high-strength, warping-resistant flame-retardant PC composite material according to claim 1.

11. The outdoor communication device to claim 10, wherein the composite PC raw material comprises a high-viscosity PC and a low-viscosity PC, the high-viscosity PC has a melt index of 10-18 g/10 min at 330° C./2.16 kg; the melt index of the low-viscosity PC at 300° C./1.2 kg is not less than 15 g/10 min.

12. The outdoor communication device according to claim 10, wherein the composite PC raw material is composed of a PC raw material with different density gradients; the PC raw material with different density gradients comprises a high-density PC with a density of 1.6-2.2 g/cm³ and a low-density PC with a density of 1.1-1.3 g/cm³.

13. The outdoor communication device according to claim 12, wherein a mass ratio of the high-density PC to the low-density PC is (5-10):(1-5).

14. The outdoor communication device according to claim 10, wherein the glass fiber is an alkali-free chopped glass fiber having a diameter of 5-9 μm and a chopping length of 3-4.5 mm.

15. The outdoor communication device according to claim 14, wherein the glass microsphere is a high-strength hollow glass microsphere having a compressive strength of no less than 35 MPa.

16. The outdoor communication device according to claim 14, wherein the high-strength hollow glass microsphere has a particle size of 10-100 μm, and the particle size D90 of the high-strength hollow glass microsphere is not greater than 90 μm.

17. The outdoor communication device according to claim 10, wherein the lubricant comprises a long-carbon-chain alkyl acid amide; a carbon chain length of the long-carbon-chain alkyl acid amide is at least within a range of 12 to 20, and an alkyl chain length of the alkyl acid amide is at least 16 or above.

18. The outdoor communication device according to claim 17, wherein the lubricant further comprises a fatty acid salt, and a mass ratio of the fatty acid salt to the long-carbon-chain alkyl acid amide salt is 1:(1-1.5).
